(19) United States
(12) Patent Application Publication
(10) Pub. No.: US 2009/0073708 A1
(43) Pub. Date: Mar. 19, 2009

(54) Vehicle interior illumination system

(75) Inventors: Norihito Kino, Aichi-ken (JP); Satoshi Inagaki, Aichi-ken (JP); Hiroshi Ito, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 12/230,876

(22) Filed: Sep. 5, 2008

(30) Foreign Application Priority Data
Sep. 6, 2007 (JP) 2007-230862
Sep. 6, 2007 (JP) 2007-230863
Sep. 21, 2007 (JP) 2007-244773
Apr. 9, 2008 (JP) 2008-100961

(51) Int. Cl. B60Q 3/02

(52) U.S. Cl. 362/490

(57) ABSTRACT

There is provided a vehicle interior illumination system wherein a linear illumination unit having an elongated linear illuminating portion which extends in a longitudinal direction of a vehicle passenger compartment ceiling is provided along each of left- and right-hand edges of the vehicle passenger compartment ceiling and light emitted from the linear illuminating portion directly illuminates the vehicle passenger compartment.

### BACKGROUND OF THE INVENTION

1. Field of the Invention

The present invention relates to a vehicle interior illumination system.

2. Description of the Related Art

A vehicle interior light is installed within an overhead console or in a central portion of a vehicle ceiling. A former example is disclosed in Patent Document No. 1. In this example, an interior light having a direct illumination unit and an indirect illumination unit is provided within an overhead console.

Patent Document No. 1: JP-A-2001-138808

An overhead console is situated obliquely above a front seat and this position provides for very easy access thereto for operation of a system/s provided thereon. By making use of this positional advantage, various functions are now being attempted to be installed in the overhead console, including a compartment for small articles, a burglar sensor, a navigation system microphone, a camera, a garage door opener and other various switches, and it is also being required to install more functions in the overhead console. When an interior light is additionally assembled on to the overhead console where the various functions are installed, to prevent the other members installed on the overhead console from being affected by heat dissipated from the interior light, it is required to take a heat dissipation measure including the installation of a heat sink for the interior light or provision of sufficient spacing between the interior light and the other members. However, these heat dissipation measures trigger the enlargement of the overhead console. On the other hand, when the interior light is assembled within the overhead console, in the event that the driver or front seat's passenger operates the functional components provided on the overhead console, light from the interior light makes the driver or front seat's passenger feel a sensation of discomfort and the proper operation is disturbed.

In the case of a vehicle having an interior light provided in the center of a vehicle passenger compartment ceiling, the intensity of light becomes insufficient for proper visibility in those areas lying in proximity to the doors and the glove box. On the other hand, in the case of a vehicle having a sun roof provided in the center of a passenger compartment ceiling, the interior light cannot be installed in the center of the vehicle passenger compartment ceiling.

### SUMMARY OF THE INVENTION

Then, the invention has been made in view of the situations and an object thereof is to solve the problems described above.

With a view to attaining the object, according to the invention, there is provided the following configuration. Namely, according to the invention, there is provided a vehicle interior illumination system wherein a linear illumination unit having an elongated linear illuminating portion which extends in a longitudinal direction of a vehicle passenger compartment ceiling is provided along each of left- and right-hand edges of the vehicle passenger compartment ceiling and light emitted from the linear illuminating portion directly illuminates the vehicle passenger compartment.

In the vehicle interior illumination system of the invention, the pair of linear illumination units are used, and one of the linear illumination units is installed along the right-hand edge portion of the vehicle passenger compartment ceiling, while the other linear illumination unit is installed along the left-hand edge portion of the vehicle passenger compartment ceiling, whereby the passenger compartment is illuminated from both sides with good balance and widely. In addition, since no illumination unit is installed within the overhead console, the degree of freedom in configuration of the overhead console is increased, whereby it becomes possible to provide various functions therein, including a compartment for small articles, a burglar sensor, a navigation system microphone, a camera, a garage door opener and other various switches. In addition, future demands for installation of additional new functional components within the overhead console can also be dealt with properly. Furthermore, since the overhead consol can be made smaller in size, space on the vehicle passenger compartment ceiling can be used effectively. On the other hand, since no illumination unit is installed within the overhead console, a comfortable operation of the functional components installed on the overhead console can be enabled. Furthermore, in the vehicle interior illumination system of the invention, since the linear illumination units are provided not in the central portion but along the left- and right-hand edge portions of the vehicle passenger compartment ceiling, the vehicle interior illumination system of the invention can also be applied to a vehicle having a sun roof.

With a view to attaining the object, according to the invention, there is provided the following configuration. Namely, according to the invention, there is provided a vehicle interior illumination system for directly illuminating a vehicle passenger compartment, including a pair of linear illumination units each having:

a light guiding plate in which an end face constitutes a light incident portion and a front surface constitutes a light emitting portion;

a first LED lamp confronting the end face of the light guiding plate; and

a designed lens provided on the light guiding plate and adapted to take in light emitted by the light guiding plate from a rear surface and to emit the light from a linear front surface thereof towards the vehicle passenger compartment;

one of the linear illumination units being installed along a right-hand edge portion of a vehicle passenger compartment ceiling, the other linear illumination unit being provided along a left-hand edge portion of the vehicle passenger compartment ceiling.

In the vehicle interior illumination system of the invention, the pair of linear illumination units are used, and one of the linear illumination units is installed along the right-hand edge portion of the vehicle passenger compartment ceiling, while the other linear illumination unit is installed along the left-hand edge portion of the vehicle passenger compartment ceiling, whereby the passenger compartment is illuminated from both sides with good balance and widely. In addition, since no illumination unit is installed within the overhead console, the degree of freedom in configuration of the overhead console is increased, whereby it becomes possible to provide various functions therein, including a compartment for small articles, a burglar sensor, a navigation system microphone, a camera, a garage door opener and other various switches. In addition, future demands for installation of additional new functional components within the overhead console can also be dealt with properly. Furthermore, since the overhead consol can be made smaller in size, space on the vehicle passenger compartment ceiling can be used effectively. On the other hand, since no illumination unit is installed within the overhead console, a comfortable operation of the functional components installed on the overhead console can be enabled. Furthermore, in the vehicle interior illumination system of the invention, since the linear illumination units are provided not in the central portion but along the left- and right-hand edge portions of the vehicle passenger compartment ceiling, the vehicle interior illumination system of the invention can also be applied to a vehicle having a sun roof.

Further, with a view to attaining the object, according to the invention, there is provided the following configuration. Namely, according to the invention, there is provided a vehicle interior illumination system for directly illuminating a vehicle passenger compartment, including a pair of linear illumination units each having:

a light guiding plate in which an end face constitutes a light incident portion and a front surface constitutes a light emitting portion;

a first LED lamp confronting the end face of the light guiding plate; and

a designed lens provided on the light guiding plate and adapted to take in light emitted by the light guiding plate from a rear surface and to emit the light from a linear front surface thereof towards the vehicle passenger compartment;

one of the linear illumination units being installed along a right-hand edge portion of a vehicle passenger compartment ceiling, the other linear illumination unit being provided along a left-hand edge portion of the vehicle passenger compartment ceiling.

In the vehicle interior illumination system of the invention, the pair of linear illumination units are used, and one of the linear illumination units is installed along the right-hand edge portion of the vehicle passenger compartment ceiling, while the other linear illumination unit is installed along the left-hand edge portion of the vehicle passenger compartment ceiling, whereby the passenger compartment is illuminated from both sides with good balance and widely. In addition, since no illumination unit is installed within the overhead console, the degree of freedom in configuration of the overhead console is increased, whereby it becomes possible to provide various functions therein, including a compartment for small articles, a burglar sensor, a navigation system microphone, a camera, a garage door opener and other various switches. In addition, future demands for installation of additional new functional components within the overhead console can also be dealt with properly. Furthermore, since the overhead consol can be made smaller in size, space on the vehicle passenger compartment ceiling can be used effectively. On the other hand, since no illumination unit is installed within the overhead console, a comfortable operation of the functional components installed on the overhead console can be enabled. Furthermore, in the vehicle interior illumination system of the invention, since the linear illumination units are provided not in the central portion but along the left- and right-hand edge portions of the vehicle passenger compartment ceiling, the vehicle interior illumination system of the invention can also be applied to a vehicle having a sun roof.

Further, with a view to attaining the object, according to the invention, there is provided the following configuration. Namely, according to the invention, there is provided a vehicle interior illumination system for directly illuminating a vehicle passenger compartment including a linear illumination unit having:

an elongated light guiding plate in which an end face constitutes a light incident portion and a front surface constitutes a light emitting portion;

a first LED lamp confronting one of end faces of the light guiding plate;

a designed lens provided on the light guiding plate and adapted to take in light emitted by the light guiding plate from a rear surface and to emit the light from a linear front surface thereof towards the vehicle passenger compartment;

a cushion piece disposed on an opposite side to the surface of the light guiding plate where the designed lens is disposed; and

a casing which holds the light guiding plate and the cushion piece between the designed lens and itself, wherein

the linear illumination unit is installed on a vehicle passenger compartment ceiling.

In the vehicle interior illumination system of the invention, the pair of linear illumination units are used, and one of the linear illumination units is installed along the right-hand edge portion of the vehicle passenger compartment ceiling, while the other linear illumination unit is installed along the left-hand edge portion of the vehicle passenger compartment ceiling, whereby the passenger compartment is illuminated from both sides with good balance and widely. In addition, since no illumination unit is installed within the overhead console, the degree of freedom in configuration of the overhead console is increased, whereby it becomes possible to provide various functions therein, including a compartment for small articles, a burglar sensor, a navigation system microphone, a camera, a garage door opener and other various switches. In addition, future demands for installation of additional new functional components within the overhead console can also be dealt with properly. Furthermore, since the overhead consol can be made smaller in size, space on the vehicle passenger compartment ceiling can be used effectively. On the other hand, since no illumination unit is installed within the overhead console, a comfortable operation of the functional components installed on the overhead console can be enabled. Furthermore, in the vehicle interior illumination system of the invention, since the linear illumination units are provided not in the central portion but along the left- and right-hand edge portions of the vehicle passenger compartment ceiling, the vehicle interior illumination system of the invention can also be applied to a vehicle having a sun roof.

### BRIEF DESCRIPTION OF THE DRAWINGS

FIG. 1 is a perspective view of a vehicle passenger compartment ceiling which includes a vehicle interior illumination system 1 which is an embodiment of the invention.

FIG. 2 is a top view of a first linear illumination unit 10a.

FIG. 3 is a vertical sectional view of the first linear illumination unit 10a taken along the line A-A in FIG. 2.

FIG. 4 is a perspective view of a vehicle passenger compartment ceiling 460 which is included in a vehicle illumination system 400 according to second embodiment of the invention.

FIG. 5 is an enlarged sectional view taken along the line B-B in FIG. 4.

FIG. 6 is an exemplary diagram illustrating an attaching method of a first linear illumination unit 410a.

FIG. 7 is a vertical sectional view of the first linear illumination unit 10a according to third embodiment of the invention.

### DESCRIPTION OF THE PREFERRED EMBODIMENTS

In this invention, a pair of linear illumination units are installed on a passenger compartment ceiling, and one of the pair of linear illumination units is installed along a right-hand edge portion, while the other illumination unit is installed along a left-hand edge portion of the vehicle passenger compartment ceiling. The linear illumination units are preferably provided in a laterally symmetrical positional relationship based on a center line of the vehicle passenger compartment ceiling. This is because the balance with which the vehicle passenger compartment is illuminated is improved. In addition, the left and right linear illumination units may be controlled to be illuminated individually. The linear illumination unit has an elongated linear illuminating portion which extends in a longitudinal direction of the vehicle passenger compartment ceiling. When used herein, the “linear” means a shape which extends in a straight line or curved line and may have a desired width. For example, the shape of the linear illuminating portion may be formed into a moderately curved shape which matches the shape of the vehicle passenger compartment ceiling. A longitudinal length of the linear illuminating portion can be about 0.5 to 0.9, about 0.5 to 0.8 or 0.6 to 0.75 time a longitudinal length of the passenger compartment ceiling. For example, the longitudinal length of the linear illuminating portion can be 500 mm to 3000 mm, 500 mm to 2000 mm or 800 mm to 1000 mm.

The linear illumination unit includes a first LED lamp as a light source. An LED lamp is advantageous in that it is small in size, its consumed power is small, and it has a long lifetime. Using, in particular, a surface-packaged type LED lamp can enable a further miniaturization of the linear illumination unit. By using such an LED lamp as a light source, the heat value of the light source is reduced, providing an advantage that the thermal effect to peripheral members is reduced. Although there is imposed no specific limitation on the color of LED lamp used, for example, colors such as white, blue and amber can be used. The linear illumination unit may further include a second LED lamp as a light source. The second LED lamp may, of course, be the same LED lamp as the first LED lamp or may be a different type of LED lamp or an LED lamp which emits light in different color.

In one mode of the invention, the linear illumination unit includes a light guiding plate. The shape of the light guiding plate can be an elongated shape which extends in a longitudinal direction of the vehicle passenger compartment ceiling. Normally, the light guiding plate has a substantially rectangular shape as viewed from the top. A longitudinal length of the light guiding plate can be about 0.5 to 0.9, about 0.5 to 0.8 or 0.6 to 0.75 time a longitudinal length of the passenger compartment ceiling. For example, the longitudinal length of the light guiding plate can be 500 mm to 3000 mm, 500 mm to 2000 mm or 800 mm to 1000 mm. There is imposed no specific limitation on a material for the light guiding plate, as long as a material used has a light guiding property, and in addition to acrylic resins, polycarbonate resins, epoxy resins and glass can be adopted. An end face of the light guiding plate constitutes a light incident portion. The first LED lamp confronts the end face. It is preferable that an opposite end face to the end face which the first LED lamp confronts is also made to constitute a light incident portion and that a second LED lamp is made to confront the opposite end face. Namely, both the end faces of the light guiding plate are preferably made to constitute light incident portions. This is because by adopting this configuration it becomes possible to realize evenness in luminance of light emitted from the linear illumination unit. A vehicle passenger compartment side surface (a front surface) of the light guiding plate constitutes a light emitting portion which emits light which is guided within the light guiding body. Although the front surface of the light guiding plate is normally smooth, a light diffusion treatment by such surface finishing as embossing and blasting may be applied to the front surface. This is because by adopting this configuration it becomes possible to realize evenness in luminance of light emitted from the linear illumination unit. In addition, part of the front surface of the light guiding plate may be made to constitute the light emitting portion.

An opposite surface to the vehicle passenger compartment (a rear surface) of the light guiding plate constitutes a reflecting portion which reflects light guided through the light guiding plate. The reflecting portion can be formed by applying a light reflecting treatment to the rear surface of the light guiding plate. As the light reflecting treatment applied to the rear surface of the light guiding plate, known methods can be adopted which includes a surface treatment such as embossing and blasting and formation of a reflection layer by coating or printing a light reflective ink or providing a light reflective tape or film. The light reflecting treatment is preferably applied in such a manner that the light reflecting action of the reflecting portion is increased from both the ends towards the center of the light guiding plate. This is because although normally, the quantity of light reaching a portion on the light guiding plate is reduced as the portion is spaced farther apart from the light incident portions, by applying the light reflecting treatment in the way described above, the light reflecting action in an area which is spaced apart from the light incident portions is increased, the quantity of light emitted from the light emitting portion becomes uniform over the whole area thereof. The reflecting portion may be formed part of the rear surface of the light guiding plate. For example, of the rear surface of the light guiding plate, areas in the vicinity of both the ends of the light guiding plate can be formed into reflecting portions. Since normally, the quantity of light reaching areas in the vicinity of the incident portions at the ends is large compared with those of the other areas of the light guiding plate, the light reaching those areas is made positive use, the evenness in luminance in light emitted from the light emitting portion is disturbed. However, by forming the reflecting portion in the way described above, since incident light is not positively reflected to the front surface side in the areas in the vicinity of the ends of the light guiding plate, the evenness in luminance of emitted light is realized.

In addition, the light guiding plate may be crystal clear or colored and transparent. Additionally, a light diffusion agent may be contained in the light guiding plate, so that light is diffused positively within the light guiding plate.

A designed lens is provided on the front surface of the light guiding plate. An opposite surface to the light guiding plate of the designed lens is exposed to the vehicle passenger compartment and constitutes a front surface of the designed lens. As with the light guiding plate, the shape f the designed lens can be an elongated shape which extends in the longitudinal direction of the vehicle passenger compartment ceiling. The designed lens takes in light emitted from the light emitting portion on the front surface of the light guiding plate from a rear surface thereof and emits the light so taken in from its linear front surface towards an interior of the vehicle passenger compartment. Namely, the front surface of the designed light constitutes an illuminating portion. The shape of the front surface of the designed lens is a linear shape. When used herein, the “linear” means a shape which extends in a straight line or curved line and may have a desired width. For example, the shape of the front surface of the designed lens may be formed into a moderately curved shape which matches the shape of the vehicle passenger compartment ceiling. As with the light guiding plate, a longitudinal length of the front surface of the designed lens can be about 0.5 to 0.9, about 0.5 to 0.8 or 0.6 to 0.75 time a longitudinal length of the passenger compartment ceiling. For example, the longitudinal length of the front surface of the designed lens can be 500 mm to 3000 mm, 500 mm to 2000 mm or 800 mm to 1000 mm. Of the pair of linear illumination units, a front side of the designed lens of the linear illumination unit installed along the right-hand edge of the passenger compartment ceiling preferably follows an outer periphery of the right-hand edge of the vehicle passenger compartment ceiling, while a front side of the designed lens of the linear illumination unit installed along the left-hand edge of the passenger compartment ceiling preferably follows an outer periphery of the left-hand edge of the vehicle passenger compartment ceiling. This is because the passenger compartment can be illuminated with good balance by disposing the pair of linear illumination units along the outer peripheries of the left- and right-hand edges of the passenger compartment ceiling. The front surface of the designed lens is preferably level with a surface of the vehicle passenger compartment ceiling preferably become level with each other. This is because a feeling that the linear illumination units are integrated into the vehicle passenger compartment ceiling is increased, thereby the design property of the illumination system are increased. The linear illumination units are preferably provided in the laterally symmetrical positional relationship based on the center line of the vehicle passenger compartment ceiling. This is because the balance with which the passenger compartment is illuminated is improved. A color conversion layer may be formed on the front surface of the designed lens. By this configuration, light in a different color from the original color of the light source can be emitted. The color conversion layer can be formed by a layer which contains a fluorescent material which is excited by light from the light source. In addition, as with the light guiding plate, the designed lens may be crystal clear or colored and transparent. Additionally, a light diffusion agent may be contained in the designed lens, so that light is positively diffused within the designed lens. Furthermore, a light diffusion layer may be provided between the front surface of the light guiding plate and the designed lens. A known light diffusion sheet may be adopted for use as the light diffusion layer.

A light diffusion treatment may be applied to a front surface or rear surface of the designed lens. As the light diffusion treatment, for example, such surface finishing as embossing and blasting or printing can be raised.

In the designed lens, an area excluding areas in proximity to the light sources is made to constitute an area exposed to the vehicle passenger compartment (that is, the front surface of the designed lens). An excessively large amount of light reaches the areas of the designed lens which lie in the vicinity of the light sources compared with the other areas thereof, and in case light so reaching the areas in question is made use of for linear illumination, the luminance balance is disturbed. Because of this, the luminance balance is maintained well by using no light available in the areas lying in proximity to the light sources.

In a vehicle in which assist grips are provided above respective doors, the vehicle interior illumination system of the invention is provided as will be described below. Namely, a front end of the front surface of the designed lens is positioned further forwards than the assist grip for a front seat, while a rear end of the front surface of the designed lens is positioned further rearwards than the assist grip for a rear seat. By disposing the designed lenses, light from the linear illumination units can illuminate not only the vehicle passenger compartment but also the assist grips, so as to increase the visibility of the assist grips during the night time.

According to an embodiment of the invention, a light guide plate has flexibility. The light guide plate having flexibility can be formed from a soft transparent resin material such as soft polypropylene-based resin and soft acryl-based resin. With the flexible light guide plate, since the light guide plate can be made to be deformed to match the shape of the ceiling of the vehicle passenger compartment on which the interior illumination system of the invention is mounted, the light guide plate can be used commonly over various types of models. By this configuration, commonization of constituent members is realized, whereby the vehicle interior illumination system of the invention becomes advantageous in terms of costs. Since the light guide plate used in the invention is long, in the event that the light guide plate is formed from a hard material, there may be caused a fear that a crack or the like is produced, and hence, the light guide plate so formed needs to be handled carefully. However, in the light guide plate having flexibility, such a crack is made difficult to be produced, and hence, the flexible light guide plate becomes easy to be handled. Furthermore, a designed lens preferably has flexibility. This is because, as with the light guide plate, commonization of constituent members is also realized with respect to the designed lens, whereby the vehicle interior illumination system of the invention also becomes advantageous in terms of costs. Furthermore, bezels and cases which are used to fix the light guide plate and the designed lens may be formed from a flexible material such as an elastomer-based material. This is because, as with the light guide plate and the designed lens, commonization of constituent components such as bezels and cases is also realized, whereby commonization of constituent members is realized further, and the vehicle interior illumination system of the invention becomes advantageous further in terms of costs. In addition, since no special design needs to be made to produce a specific linear illumination unit which matches a shape and design of a ceiling of a passenger compartment of a vehicle, steps involved in design can be reduced. Furthermore, by the light guide plate, the designed lens, and the bezels and cases for the light guide plate and designed lens being made flexible, since the interior illumination system is made to have flexibility in its entirety, the interior illumination system of the invention becomes much easier to match various types of ceilings in shape and design of passenger compartments of vehicles, and since the whole of the interior illumination system can be made into a shape which extends along the shape of a ceiling of a passenger compartment of a vehicle, the design properties are increased.

Hereinafter, an embodiment of the invention will be described.

### Embodiment 1

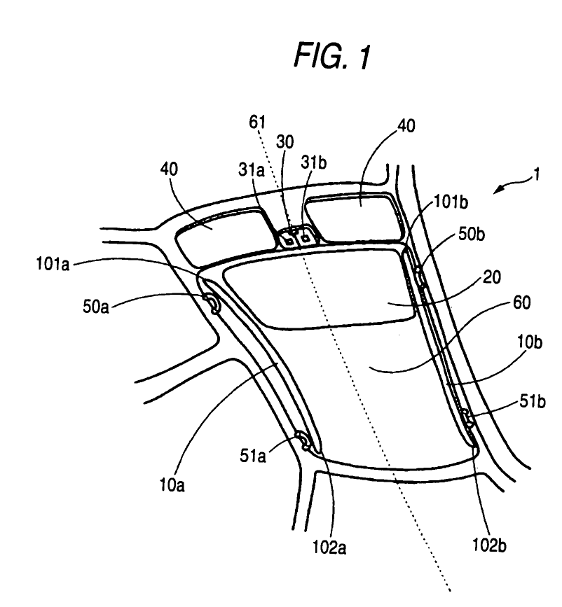

FIG. 1 is a perspective view of a vehicle passenger compartment ceiling 60 which includes a vehicle illumination system 1 which is an embodiment of the invention. Provided on the passenger compartment ceiling are a first linear illumination unit 10a, a second linear illumination unit 10b, a sun roof 20, an overhead console 30, sun visors 40, and assist grips 50a, 50b, 51a, 51b. The first linear illumination unit 10a is provided further inwards towards the center of a vehicle passenger compartment ceiling 60 than the assist grips 50a, 51a provided on a driver's seat side of the vehicle passenger compartment ceiling 60 and in such a manner as to follow an outer periphery of a driver's side edge of the vehicle passenger compartment ceiling 60. A front end 101a of the first linear illumination unit 10a is positioned further forwards than the driver's seat side assist grip 50a, while a rear end 102a of the first linear illumination unit 10a is positioned further rearwards than the driver's seat side assist grip 51a. On the other hand, the second linear illumination unit 10b is provided further inwards towards the center of the vehicle passenger compartment ceiling 60 than the assist grips 50b, 51b provided on a front passenger's seat side of the vehicle passenger compartment ceiling 60 and in such a manner as to follow an outer periphery of a front passenger's seat side edge of the vehicle passenger compartment ceiling 60. As with the first linear illumination unit 10a, a front end 101b of the second linear illumination unit 10b is positioned further forwards than the front passenger's seat side assist grip 50b, while a rear end 102b of the second linear illumination unit 10b is positioned further rearwards than the front passenger's seat side assist grip 51b. The first linear illumination unit 10a and the second linear illumination unit 10b are provided in a laterally symmetrical positional relationship based on a center line 61 of the vehicle passenger compartment ceiling 60.

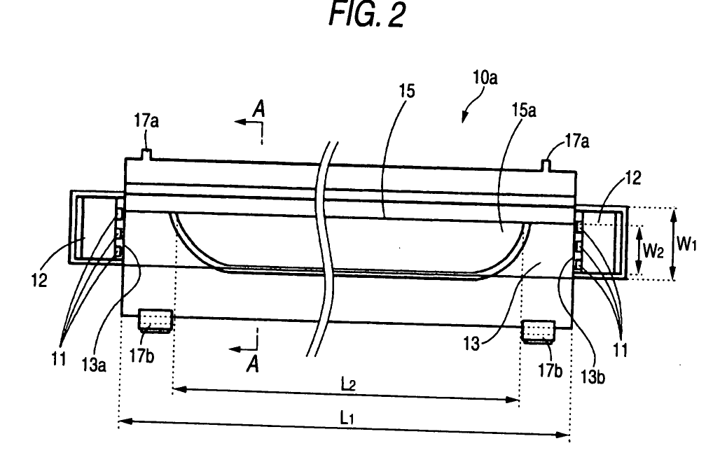

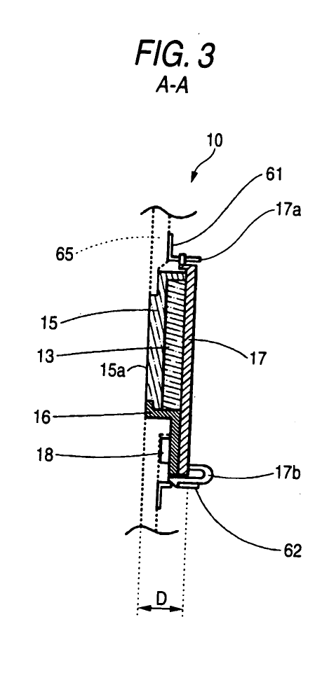

Being taken out from FIG. 1, a front view of the first linear illumination unit 10a is shown in FIG. 2, and a sectional view sectioned along the line A-A in FIG. 2 is shown in FIG. 3. The first linear illumination unit 10a includes LED lamps 11, heat sinks 12, a light guiding plate 13, a designed lens 15, a bezel 16 and a casing 17. The LED lamps are a surface-packed type while LED lamp. The LED lamps 11 are provided three in such a manner as to confront an end face 13a of the light guiding plate 13. The heat sink 12 is provided on a back side of the three LED lamps 11. Similarly, the LED lamps 11, which are three, and the heat sink 12 are also provided at an opposite end face 13b. The light guiding plate 13 is made of a crystal clear acrylic resin and is formed into a linear shape which extends in a longitudinal direction of the vehicle passenger compartment ceiling 60. A longitudinal length L₁ of the light guiding plate 13 is about 960 mm, and a width W₁ is about 30 mm. As is shown in FIG. 3, the designed lens 15 is provided on a front surface (a vehicle passenger compartment side surface) of the light guiding plate 13. The thickness of the first linear illumination unit 10a is about 15 mm. The designed lens 15 is made of acryl. The designed lens 15 has a front surface 15a which is exposed to an interior of a vehicle passenger compartment on an opposite side to a side thereof which faces the light guiding plate 13. The shape of the front face or light emitting surface 15a is a linear shape which extends in the longitudinal direction of the vehicle passenger compartment ceiling 60 and is a one size smaller shape than the size of the light guiding plate 13. A longitudinal length L₂ of the front surface 15a is about 920 mm and a width W2 is about 25 mm. The bezel 16 is provided below the light guiding plate 13 and the designed lens 15. The bezel 16 is exposed to the interior of the passenger compartment along a lower edge portion of the front surface 15a.

Dots are printed in white ink on a rear surface (an opposite surface to the vehicle passenger compartment side surface) of the light guiding plate 13. The dot density is increased as dots go apart from the LED lamps 11. Namely, dots are printed in such a manner that the dot density is increased as they go towards the center of the light guiding plate 13. The casing 17 is provided on the rear surface of the light guiding plate 13. The bezel 16 is fixed to the casing 17 with screws 18, whereby the designed lens 15 and the light guiding plate 13 are held between the casing 17 and the bezel 16 in that order. The casing 17 includes projections 17a on an upper edge portion and engagement claws 17b on a lower edge portion thereof. Locking portions 61 and engagement portions 62 are attached to an opposite side of the vehicle compartment ceiling 60 (indicated by broken lines in FIG. 3) to a side facing an interior of the passenger compartment. Holes are formed in the locking portions 61 and the projecting portions 17a of the casing 17 are fitted in the holes so formed. On the other hand, holes are also formed in the engagement portions 62, and the engagement claws 17b of the casing 17 are brought into engagement with the holes so formed. In mounting the first linear illumination unit 10a, firstly, the projecting portions 17a are fitted in the locking portions 61 so as to be locked in place therein, and thereafter, the whole of the first linear illumination unit 10a is rotated on the locking portions 61 as fulcrums to be fitted in so that the engagement claws 17b are brought into engagement with the engagement portions 62. The second linear illumination unit 10b also has the same configuration as that of the first linear illumination unit 10a.

In addition, in addition to a small articles compartment, a burglar sensor, a navigation system microphone, a camera, a help net, and a garage door opener (not shown), switches 31a, 31b are provided on the overhead console 30 for controlling the illumination of the first linear illumination unit 10a and the second linear illumination unit 10b.

Next, an illumination mode of the illumination system 1 will be described. By the switches 31a, 31b being turned on, or in association with a vehicle door being opened, the LED lamps are illuminated. Light from the LED lamps is incident on the light guiding plate 13 and is guided within the light guiding plate 13. Light being guided within the light guiding plate 13 is reflected on the rear surface of the light guiding plate 13 or travels directly to the front surface side of the light guiding plate 13, so as to be emitted from the front surface (a light emitting portion) of the light guiding plate 13. Emitted light is then incident on the designed lens 15 from the rear surface of the designed lens 15 so as to be emitted into the vehicle passenger compartment from the front surface 15a. In this way, the vehicle passenger compartment is directly illuminated by the first linear illumination unit 10a and the second linear illumination unit 10b. Here, since the first linear illumination unit 10a and the second linear illumination unit 10b are provided along the left- and right-hand sides of the vehicle passenger compartment ceiling 60, there is caused no problem with an installing position with the sun roof 20 which is provided in the center of the vehicle passenger compartment ceiling 60. Furthermore, in operating the small articles compartment, the burglar sensor, the navigation system microphone, the camera, the help net, and the garage door opener which are provided on the overhead console 30, even though the operator looks at the overhead console 30, the first linear illumination unit 10a and the second linear illumination unit 10b do not reside at the end of the line of sight, whereby the risk is reduced that the operator is dazzled by light from the first linear illumination unit 10a and the second linear illumination unit 10b when he or she operates the functional components on the overhead console 30. In addition, the front end 101a of the first linear illumination unit 10a is positioned further forwards than the driver's seat side assist grip 50a, and the rear end 102a of the first linear illumination unit 10a is positioned further rearwards than the driver's seat side assist grip 51a. By this configuration, since the first linear illumination unit 10a illuminates not only the vehicle passenger compartment but also the assist grips 50a, 51a, the visibility of the assist grips 50a, 51a in a dark place is increased. Similarly, the visibility of the assist grips 50b, 51b is increased by the second linear illumination unit 10b. Furthermore, since the first linear illumination unit 10a and the second linear illumination unit 10b are elongated in the manner described above, a wide range within the vehicle passenger compartment is illuminated, whereby the visibility of the vehicle passenger compartment in a dark place as during the night time. In addition, since the first linear illumination unit 10a and the second linear illumination unit 10b are provided along the left- and right-hand side portions of the vehicle passenger compartment ceiling 60 in the laterally symmetrical fashion, the vehicle passenger compartment is illuminated with good balance, this also contributing to the increase in visibility of the passenger compartment in a dark place as during the night time. In this way, since the linear illumination units are not provided within the overhead console 30, compared with a case where they are provided within the overhead console 30, the overhead console 30 can be configured small in size, whereby space on the vehicle passenger compartment ceiling 60 can be used effectively. In addition, the degree of freedom in designing the overhead console 30 is increased.

On the other hand, the dots are printed on the rear surface of the light guiding plate 13 in such a manner that the dot density is increased as the dots go from both the ends towards the center of the light guiding plate 13, whereby the diffuse reflection effect is increased from both the ends towards to the center of the light guiding plate 13. Although normally, the quantity of light incident from both the end faces 13a of the light guiding plate 13 decreases as it travels from both the end towards the center of the light guiding plate 13, the quantity of light emitted from the front surface 15a is made uniform over the whole area thereof by virtue of the dots printed on the rear surface of the light guiding plate 13 in the manner described above. However, since the front surface 15a is formed about 20 mm inwards from both the end faces 13a of the light guiding plate 13, light from the areas in the vicinity of the end faces 13a of the light guiding plat 13 is not used positively for illumination of the front surface 15a. As a result of this, the evenness in luminance of light emitted from the front surface 15a is realized further, whereby the vehicle passenger compartment is illuminated well. As is shown in FIG. 3, the front surface 15a continues to the vehicle passenger compartment ceiling 60 in such a manner as to become level therewith. This increases a sensation of integration of the first linear illumination unit 10a and the second linear illumination unit 10b with the vehicle passenger compartment ceiling 60, thereby the vehicle interior illumination system having the high design property being provided.

In addition, map lamps may be provided as well in the vicinity of the first linear illumination unit 10a and the second linear illumination unit 10b. For example, map lamps can be provided at the front of the front end 101a of the first linear illumination unit 10a and at the front of the front end 101b of the second linear illumination unit 10b. By adopting this configuration, a sensation of integration of the vehicle interior illumination system 1 with the map lamps so provided is obtained, whereby the design property of the vehicle interior illumination system is increased further.

### Embodiment 2

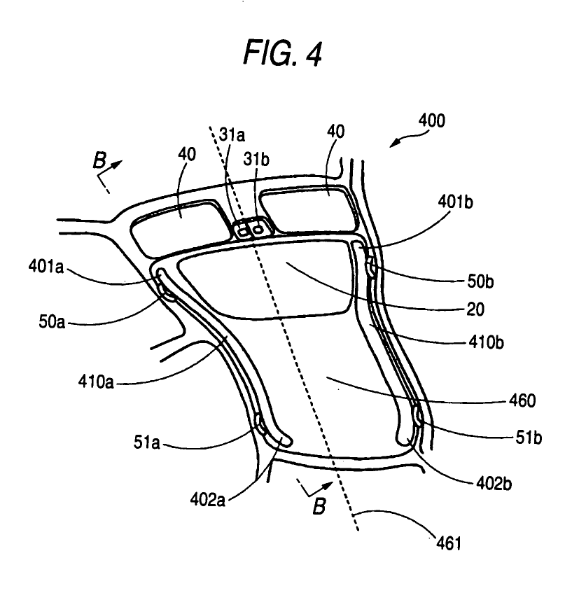

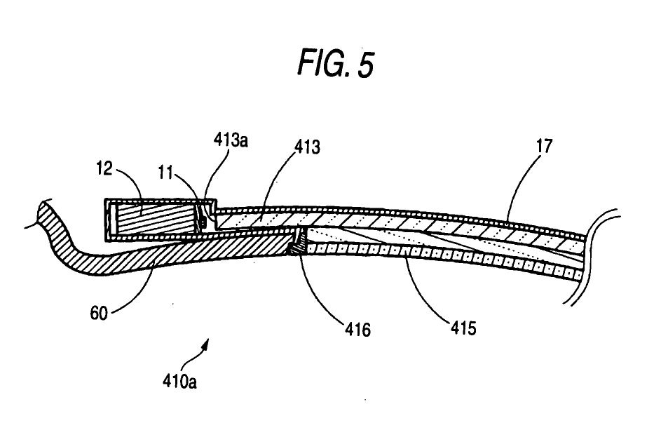

FIG. 4 shows a perspective view of a ceiling 460 of a passenger compartment of a vehicle which includes a vehicle illumination system 400 of another embodiment or Embodiment 2 of the invention, and FIG. 5 shows an enlarged sectional view taken along the line B-B in FIG. 4. Like reference numerals will be imparted to like members to the members described in Embodiment 1, and the description thereof will be omitted. Provided on a passenger compartment ceiling are a first linear illumination unit 410a, a second linear illumination unit 410b, a sun roof 20, an overhead console 30, sun visors 40, and assist grips 50a, 50b, 51a, 51b. The first linear illumination unit 410a is provided at a driver's seat side edge portion of a vehicle passenger compartment ceiling 460 in such a manner as to lie further inwards towards the center of the vehicle passenger compartment ceiling 460 than the assist grips 50a, 51a provided on a driver's seat side of the vehicle passenger compartment ceiling 460 and in such a manner as to follow an outer periphery of the driver's seat side edge of the vehicle passenger compartment ceiling 460. A front end 401a of the first linear illumination unit 410a is positioned further forwards than the driver's seat side assist grip 50a, while a rear end 402a of the first linear illumination unit 410a is positioned further rearwards than the driver's seat side assist grip 51a. On the other hand, the second linear illumination unit 410b is provided at a front passenger's seat side edge portion of the vehicle passenger compartment ceiling 460 in such a manner as to lie further inwards towards the center of the vehicle passenger compartment ceiling 460 than the assist grips 50b, 51b provided on a front passenger's seat side of the vehicle passenger compartment ceiling 460 and in such a manner as to follow an outer periphery of the front passenger's seat side edge of the vehicle passenger compartment ceiling 460. As with the first linear illumination unit 410a, a front end 401b of the second linear illumination unit 410b is positioned further forwards than the front passenger's seat side assist grip 50b, while a rear end 402b of the second linear illumination unit 410b is positioned further rearwards than the front passenger's seat side assist grip 51b. The first linear illumination unit 410a and the second linear illumination unit 410b are provided in a laterally symmetrical positional relationship based on a center line 461 of the vehicle passenger compartment ceiling 460. Here, the outer periphery of the vehicle passenger compartment ceiling 460 is curved, and the first linear illumination unit 410a and the second linear illumination unit 410b which are disposed along the outer periphery so curved are both installed in a curved state.

As is shown in FIG. 5, the first linear illumination unit 410a includes LED lamps 11, heat sinks 12, a light guiding plate 413, a designed lens 15, a bezel 416 and a casing 17. The LED lamps 11 are provided three in such a manner as to confront an end face 413a of the light guiding plate 413. The heat sink 12 is provided on a back side of the three LED lamps 11. Similarly, the LED lamps 11, which are three, and the heat sink 12 are also provided at an opposite end face 413b (not shown). The light guiding plate 413 is made of a crystal clear soft polypropylene-based resin and hence has flexibility. The light guide plate 413 is formed into a substantially linear shape which extends in a longitudinal direction of the vehicle passenger compartment ceiling 460, and its longitudinal length and width are about 960 mm and about 30 mm, respectively. The designed lens 415 is provided on a front surface (a vehicle passenger compartment side surface) of the light guiding plate 413. The designed lens 415 is made of soft acryl-based resin and hence has flexibility. The bezel 416 is provided below the light guide plate 413 and the designed lens 415. The bezel 416 is made from elastomer and hence has flexibility. The besel 416 is exposed to the interior of the passenger compartment along an edge portion of the designed lens 415.

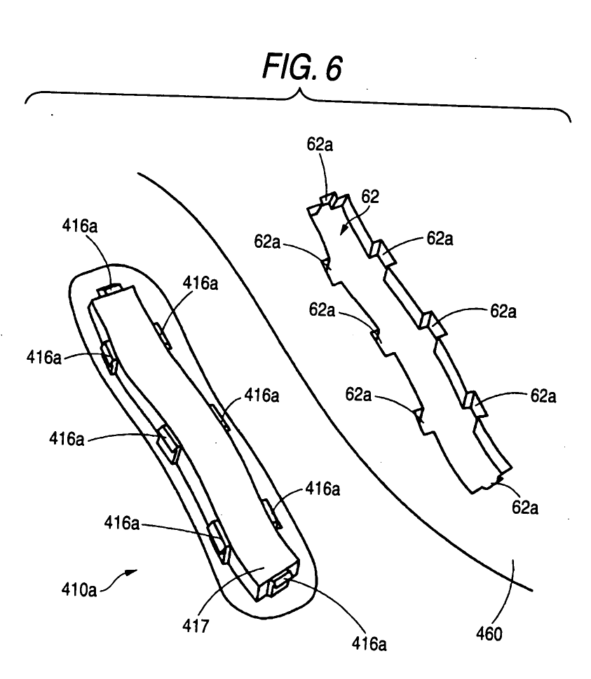

FIG. 6 shows an exemplary diagram which illustrates an attaching method of the first linear illumination unit 410a. An attaching hole portion 62 is provided along the edge portion of the vehicle passenger compartment ceiling 460. The attaching hole portion 62 has the same shape as an external shape of a back portion 417 of the first linear illumination unit 410a. A plurality of claw portions 416a are provided on a vehicle ceiling side of the bezel 416. On the other hand, notches 62a are provided on wall surfaces of the attaching hole portion 62 in positions which correspond to the claws 416a. Here, since the light guide plate 413, the designed lens 415 and the bezel 416 are all flexible, the first linear illumination unit 410a is flexible in its entirety. By the first linear illumination unit 410a which is so flexible being flexed, the first linear illumination unit 410a is fitted in the attaching hole portion 62 from the inside of the passenger compartment, whereupon the claws 416a are brought into engagement with the notches 62a on the attaching hole portion 62, whereby the first linear illumination unit 410a is fixed in place in the attaching hole portion 62. As is shown in FIG. 4, the edge portion of the passenger compartment ceiling 460 is curved, and the attaching hole portion 62 is also curved to follow the curved edge portion. Since the first linear illumination unit 410a is flexible in its entirety, the first linear illumination unit 410a is provided along the curved attaching hole portion 62 in a curved state. Since the first linear illumination unit 410a has the flexibility in this way, the first linear illumination unit 410a can be curved to match not only the shape of the attaching hole portion 62 but also other shapes. Because of this, the first linear illumination unit 410a can be used on other vehicles of which passenger compartment ceilings are different in shape. Consequently, the commonization of constituent members is realized, and the vehicle interior illumination system adopting the configuration described above becomes advantageous in terms of costs. In addition, since no special design needs to be made to make a specific linear illumination unit which matches a shape and design of a ceiling of a passenger compartment of a vehicle, steps involved in design can be reduced. Since the first linear illumination unit 410a can be formed in its entirety into the shape which matches the shape of the vehicle passenger compartment ceiling, the design properties can be increased. The second linear illumination unit 410b is provided laterally symmetrical with the first linear illumination unit 410a and hence provides the same advantage. The same advantage as that provided by the vehicle illumination system 1 can also be provided by the vehicle illumination system 400.

### Embodiment 3

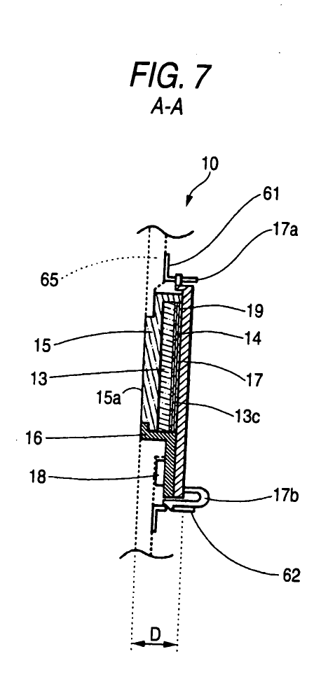

In the embodiment 1, the casing 17 is provided on the rear surface of the light guiding plate 13, However, in this embodiment 3, as shown in FIG. 7, a reflection layer 13c is provided on a rear surface (an opposite surface to the vehicle passenger compartment side surface) of the light guiding plate 13, the casing 17 is provided on the reflection layer 13c (the opposite surface to the vehicle passenger compartment side surface) of the light guiding plate 13 via the reflection sheet 4 and a cushion piece 19. The bezel 16 is fixed to the casing 17 with screws 18, whereby the designed lens 15, the light guiding plate 13, the reflection sheet 14 and the cushion piece 19 are held between the casing 17 and the bezel 16 in that order. Here, like reference numerals is imparted to like members to the members described in Embodiment 1, and the description thereof will be omitted.

In embodiment 1, by the switches 31a, 31b being turned on, or in association with a vehicle door being opened, the LED lamps are illuminated. Light from the LED lamps is incident on the light guiding plate 13 and is guided within the light guiding plate 13. Light being guided within the light guiding plate 13 is reflected on the rear surface of the light guiding plate 13 or travels directly to the front surface side of the light guiding plate 13, so as to be emitted from the front surface (a light emitting portion) of the light guiding plate 13. Emitted light is then incident on the designed lens 15 from the rear surface of the designed lens 15 so as to be emitted into the vehicle passenger compartment from the front surface 15a. However, in the embodiment 3, by the switches 31a, 31b being turned on, or in association with a vehicle door being opened, the LED lamps are illuminated. Light from the LED lamps is incident on the light guiding plate 13 and is guided within the light guiding plate 13. Light being guided within the light guiding plate 13 is reflected on the rear surface of the light guiding plate 13 or travels directly to the front surface side of the light guiding plate 13, so as to be emitted from the front surface (a light emitting portion) of the light guiding plate 13. Emitted light is then incident on the designed lens 15 from the rear surface of the designed lens 15 so as to be emitted into the vehicle passenger compartment from the front surface 15a.

In addition, since the first linear illumination unit 10a and the second linear illumination unit 10b are provided, respectively, along the left- and right-hand edges of the vehicle passenger compartment ceiling, the first linear illumination unit 10a and the second linear illumination unit 10b are formed in such a way as to each have a moderately curved line along the vehicle passenger compartment ceiling. However, since the first linear illumination unit 10a and the second linear illumination unit 10b are the elongated product in which the longitudinal length L₁ of the light guiding plate 13 is about 960 mm and the width W₁ is about 40 mm, although they are molded in advance as an injection molded product which is given a shape matching a mounting construction, the cushion piece 19 is interposed to prevent the strong contact between the light guiding plate 13 and the casing 17 via the reflection sheet 14, which would otherwise be the case due to a molding tolerance or the like, whereby abnormal illumination (bright-line line illumination or the like) at the portion of the light guiding plate where the strong contact with the casing 17 via the reflection sheet 14 is occurring.

By this configuration, illumination in which a sensation of evenness in luminance is increased can be obtained by the first linear illumination unit 10a and the second linear illumination unit 10b.

The invention can be applied to various types of vehicles (passenger vehicles, buses and the like).

The invention is not limited at all to the mode for carrying out the invention and the embodiment thereof. Various modified forms or examples are included in the invention that are made within a range that can easily be conceived by those skilled in the art to which the invention pertains without departing from the spirit and scope of the invention.

The contents of the theses, unexamined patent publications and examined patent publications which are referred to in this specification are included herein in their entireties by reference.

1. A vehicle interior illumination system, comprising:
a linear illumination unit having an elongated linear illuminating portion which extends in a longitudinal direction of a vehicle passenger compartment ceiling;
wherein the linear illumination unit is provided along each of left- and right-hand edges of the vehicle passenger compartment ceiling; and light emitted from the linear illuminating portion directly illuminates the vehicle passenger compartment.

2. The vehicle interior illumination system according to claim 1, wherein the linear illuminating portion is situated further inwards towards the center of the vehicle passenger compartment ceiling than assists grips provided thereon.

3. The vehicle interior illumination system according to claim 1, wherein a front end of the linear illuminating portion is situated further forwards than the assist grip for a front seat, and a rear end of the linear illuminating portion is situated further rearwards than the assist grip for a rear seat.

4. The vehicle interior illumination system according to claim 1, wherein a longitudinal length of the linear illuminating portion is about 0.5 to 0.9 time a longitudinal length of the vehicle passenger compartment ceiling.

5. The vehicle interior illumination system according to claim 1, wherein the linear illuminating portions are installed in a laterally symmetrical positional relationship across a center line of the vehicle passenger compartment ceiling which functions as an axis of symmetry.

6. The vehicle interior illumination system according to claim 1, wherein a surface of the linear illuminating portion and a surface of the vehicle passenger compartment ceiling become level with each other.

7. A vehicle interior illumination system for directly illuminating a vehicle passenger compartment comprising a pair of linear illumination units each having:
a light guiding plate in which an end face constitutes a light incident portion and a front surface constitutes a light emitting portion;
a first LED lamp confronting the end face of the light guiding plate; and
a designed lens provided on the light guiding plate and adapted to take in light emitted by the light guiding plate from a rear surface and to emit the light from a linear front surface thereof towards the vehicle passenger compartment;
one of the linear illumination units being installed along a right-hand edge portion of a vehicle passenger compartment ceiling, the other linear illumination unit being provided along a left-hand edge portion of the vehicle passenger compartment ceiling.

8. The vehicle interior illumination system according to claim 7, wherein an opposite end face of the light guiding plate to the end face which confronts the first LED lamp also constitutes a light incident portion and a second LED lamp is provided in such a manner as to confront the opposite end face.

9. The vehicle interior illumination system according to claim 7, wherein the one linear illumination unit is disposed in such a manner that the front surface of the designed lens follows along an outer periphery of a right-hand edge of the vehicle passenger compartment ceiling, and the other linear light illumination is disposed in such a manner that the front surface of the designed lens follow an outer periphery of a left-hand edge of the vehicle passenger compartment ceiling.

10. The vehicle interior illumination system according to claim 7, wherein a longitudinal length of the front surface of the design lens is about 0.5 to 0.9 time a longitudinal length of the vehicle passenger compartment ceiling.

11. The vehicle interior illumination system according to claim 7, wherein the pair of linear illumination units are disposed in a laterally symmetrical positional relationship across a center line of the vehicle passenger compartment ceiling which functions as an axis of symmetry.

12. The vehicle interior illumination system according to claim 7, wherein the front surface of the designed lens of the linear illumination unit is positioned further inwards towards the center of the vehicle passenger compartment ceiling than assist grips.

13. The vehicle interior illumination system according to claim 7, wherein a front end of the front surface of the designed lens is positioned further forwards than the assist grip for a front seat, and a rear end of the front surface of the designed lens is positioned further rearwards than the assist grip for a rear seat.

14. A vehicle interior illumination system as set forth in claim 1, wherein the front surface of the designed lens becomes level with the vehicle passenger compartment ceiling.

15. The vehicle interior illumination system according to claim 1, wherein a diffusion layer is provided between the front surface of the light guiding plate and the designed lens.

16. A vehicle interior illumination system for directly illuminating a vehicle passenger compartment, comprising;
a linear illumination unit having:
an elongated light guiding plate in which an end face constitutes a light incident portion and a front surface constitutes a light emitting portion;
a first LED lamp confronting one of end faces of the light guiding plate;
a designed lens provided on the light guiding plate and adapted to take in light emitted by the light guiding plate from a rear surface and to emit the light from a linear front surface thereof towards the vehicle passenger compartment;
a cushion piece disposed on an opposite side to the surface of the light guiding plate where the designed lens is disposed; and
a casing which holds the light guiding plate and the cushion piece between the designed lens and itself, wherein
the linear illumination unit is installed on a vehicle passenger compartment ceiling.

17. The vehicle interior illumination system as set forth in claim 16, wherein the linear illumination unit has further a reflection sheet between the light guiding plate and the cushion piece.

18. The vehicle interior illumination system as set forth in claim 17, wherein the linear illumination unit has further a second LED lamp which confronts the other end face of the light guiding plate, wherein
the linear illumination unit is installed in pair in such a manner as to be positioned further inwards towards the center of a vehicle than assist grips on a driver's seat side of a vehicle passenger compartment ceiling and further inwards towards the center of the vehicle than assist grips on a front passenger's seat side of the vehicle passenger compartment ceiling, respectively, and wherein
the pair of linear illumination units so installed are disposed in a laterally symmetrical positional relationship across a center line of the vehicle passenger compartment ceiling which functions as an axis of symmetry.

19. The vehicle interior illumination system as set forth in claim 18, wherein a front end of the front surface of the designed lens is positioned further forwards than the assist grip for a front seat, wherein
a rear end of the front surface of the designed lens is positioned further rearwards than the assist grip for a rear seat, and wherein
the front surface of the designed lens becomes level with a surface of the vehicle passenger compartment ceiling.

20. A vehicle interior illumination system as set forth in claim 2, wherein the front surface of the designed lens becomes level with the vehicle passenger compartment ceiling.
